(19) United States
(12) Patent Application Publication
(10) Pub. No.: US 2004/0181398 A1
(43) Pub. Date: Sep. 16, 2004

(54) Apparatus for coding wide-band low bit rate speech signal

(76) Inventors: Ho Sang Sung, Daejeon-city (KR); Dae Hwan Hwang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/749,544

(22) Filed: Dec. 30, 2003

(30) Foreign Application Priority Data
Mar. 13, 2003 (KR) 2003-15683

(51) Int. Cl. G10L 19/04

(52) U.S. Cl. 704/219

(57) ABSTRACT

There is provided an encoder for a wide-band low transmission rate speech signal, which includes: a pre-processing and down-sampling unit, which down-samples a speech signal frame sampled at a high frequency, at a low frequency, and outputs a speech signal frame without DC components; a LPC analysis and ISP quantization unit, which receives the down-sampled speech signal, determines a linear prediction coefficient of the received speech signal frame, converts the linear prediction coefficient into an ISP coefficient, quantizes the converted result, and outputs an index of the ISP coefficient; a residual signal calculation unit, which calculates a residual signal that models an excitation signal of a synthesis filter for the down-sampled speech signal; a random vector generation block which generates a random vector for modeling the excitation signal; a gain calculation block, which calculates a gain for scaling the random vector; and a gain quantization block, which quantizes the gain and creates an index of the gain.

### BACKGROUND OF THE INVENTION

This application claims the priority of Korean Patent Application No. 2003-15683, filed on Mar. 13, 2003, in the Korean Intellectual Property Office, the disclosure of which is incorporated herein in its entirety by reference.

1. Field of the Invention

The present invention relates to a speech signal processing, and more particularly, to an encoder for a wide-band speech signal, and even more particularly, to an encoder for a wide-band low bit-rate speech signal.

2. Description of the Related Art

Generally, a speech signal is encoded differently according to whether the speech signal is a narrow-band signal or a wide-band signal. When the speech signal is the narrow-band signal, an analog input speech signal is sampled at 8 kHz to form 16 bit linear PCM (Pulse Code Modulation) data, which is used as an input signal of a speech encoder. When the speech signal is the wide-band signal, 16 bit linear PCM data to which an analog input signal is sampled at 16 kHz to form 16 bit linear PCM data, which is used as an input signal of the speech encoder.

Speech signal coding for the former input signal sampled at 8 kHz include ITU-T G.711-G.712 standards and G.720-G.729 series. A speech signal coding for the latter input signal sampled at 16 kHz includes ITU-T G.722 and G.722.1 and 3GPP AMR-WB (G.722.2) to be used for IMT-2000.

A representative coding method for a narrow-band speech signal is ITU-T G.723.1. ITU-T G.723.1 is an algorithm of compressing and restoring an input speech at a dual rate of 5.3 or 6.3 kbps in order to compress a multi-media signal at a low speed. ITU-T G.723.1 provides toll quality in a wired network. Also, ITU-T G.723.1 uses a hybrid coding technique in which waveform coding and parameter coding are mixed and is a CELP (Code Excited Linear Prediction) type speech coding.

ITU-T G.722 is a coding method for a wide-band speech signal and has transmission rates of 64, 56, and 48 kbps and provides face-to-face communication quality. ITU-T G.722 divides a band into two sub-bands and encodes the respective sub-bands using ADPCM (Adaptive Differential Pulse Code Modulation).

3GPP AMR-WB (G.722.2) is also a coding method for a wide-band speech signal and is the latest standardized coding method. 3GPP AMR-WB is standardized for use with IMT-2000 in order to meet expanding mobile communication demands. 3GPP AMR-WB is also called G.722.2 in the ITU-T standards. G.722.2 is standardized for use in both a wired network and a wireless network. G.722.2 has nine transmission-rates, and a maximum transmission rate is 23.85 kbps. At the maximum transmission-rate, ITU-T G.722.2 provides a superior tone quality to ITU-T G.722 at 64 kbps.

A low bit rate speech encoder that provides a level of toll quality capable of being achieved in a wired network can provide new services in mobile communication, Internet telephony, etc., due to its high frequency efficiency. Particularly, usage of VoIP (Voice over Internet Protocol) has exponentially spread over the Internet network. However, it is appraised low due to competitive telephone charges.

Various methods have been developed to prevent service quality from deteriorating due to low speech quality and speech processing delay which cause adverse effects in the spread of speech communication over the Internet. One of these methods is a VoIP service for a wide-band speech signal. Such a service for the wide-band signal provides many improvements in speech quality.

The above-mentioned AMR-WB, which is the latest standardized codec for the wide-band speech, uses a general CELP method and has nine transmission-rate modes, the lowest transmission rate being 6.6 kbps. A disadvantage of this speech codec is that it cannot support a source controlled variable transmission rate. That is, this codec cannot reflect certain characteristics of an input speech signal, since it uses only predetermined transmission rates. Also, since a VAD (Voice Activity Detection) algorithm provided in the standards determines only whether an input signal is voiced or unvoiced, a problem occurs in the transmission of silence.

Accordingly, a new VAD algorithm capable of correctly dividing input signals according to their characteristics is needed to completely support the source controlled variable transmission rate. It is also needed to flexibly control transmission rates according to the characteristics of input signals.

### SUMMARY OF THE INVENTION

The present invention provides an encoder for a wide-band low transmission rate speech signal, capable of flexibly controlling transmission rates according to characteristics of speech signals, and more particularly, an encoder capable of processing a silence signal using a VAD algorithm.

According to an aspect of the present invention, there is provided an encoder for a wide-band low transmission rate speech signal, the encode comprising: a pre-processing and down-sampling unit, which down-samples a speech signal frame sampled at a high frequency, at a low frequency, and outputs a speech signal frame without DC components; a LPC analysis and ISP quantization unit, which receives the down-sampled speech signal, determines a linear prediction coefficient of the received speech signal frame, converts the linear prediction coefficient into an ISP coefficient, quantizes the converted result, and outputs an index of the ISP coefficient; a residual signal calculation unit, which calculates a residual signal that models an excitation signal of a synthesis filter for the down-sampled speech signal; a random vector generation block which generates a random vector for modeling the excitation signal; a gain calculation block, which calculates a gain for scaling the random vector; and a gain quantization block, which quantizes the gain and creates an index of the gain.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a functional construction of an audio unit in a conventional wide-band speech signal codec;

FIG. 2 shows a bit distribution of a 16 bit linear PCM signal;

FIG. 3 is a block diagram of an encoder according to a conventional CELP method;

FIG. 4 is a block diagram of a decoder according to a conventional CELP method;

FIG. 5 is a block diagram of an encoder according to a preferred embodiment of the present invention;

FIG. 6 shows a construction of a decoder;

FIG. 7 illustrates bit allocation performed by the encoder of FIG. 5;

FIG. 8 shows a seed generation method programmed using the C programming language; and

FIG. 9 shows a gain quantization unit of the encoder of FIG. 5.

### DETAILED DESCRIPTION OF THE INVENTION

For convenience of descriptions, a method for implementing the present invention is briefly described below.

The present invention is related to a method which divides wide-band speech signals into lower-band (50-6400 Hz) signals and upper-band (6400-7000 Hz) signals and encodes/decodes the lower-band signals of 50-6400 Hz at a low transmission rate.

An encoding/decoding method according to a preferred embodiment of the present invention is aimed at proposing a low bit rate speech codec algorithm for the interval of a silence signal when speech signals are divided into voiced, unvoiced, music, background noise, onset, silence, etc. using a VAD algorithm. Here, the silence signal includes a signal with low level of noise signal.

A basic method for implementing the present invention is a CELP (Code Excited Linear Prediction) method using a LP (Linear Prediction) analysis.

According to the preferred embodiment of the present invention, a speech signal is divided into frames of 20 ms. An LPC (Linear Prediction Coding) coefficient representing a short-term correlation for these 20 ms frames is calculated. When the LPC coefficient is calculated, a lookahead of 5 ms is used for linear prediction. Accordingly, a total delay time is 25 ms. The order of the LPC coefficient is 16. The LPC coefficient is converted into an ISP (Immittance spectral pairs) coefficient mathematically equal to the LPC coefficient in order to facilitate quantization and a stability check.

The ISP coefficient is divided and quantized. 14 bits are allocated for division and quantization. The quantized LPC coefficient is a coefficient for a second sub-frame and a coefficient for a first sub-frame can be obtained through interpolation of the LPC coefficient obtained from a previous frame. An analysis filter is constructed using the quantized LPC coefficients of the sub-frames. Then, an input signal is passed through the analysis filter to generate a residual signal. To model this residual signal, the preferred embodiment of the present invention uses a method that generates a random sequence and multiplies a proper gain by values in the random sequence. The gain is obtained through cross correlation of the residual signal and the random sequence, and is quantized by a secondary MA prediction unit and a scalar quantizer. To quantize the gain, three bits for each of the sub-frames (six bits in total) are allocated. A memory is then updated for a next frame.

Hereinafter, the preferred embodiment of the present invention will be described in detail with reference to the appended drawings. The same components of the respective drawings are denoted by the same reference number.

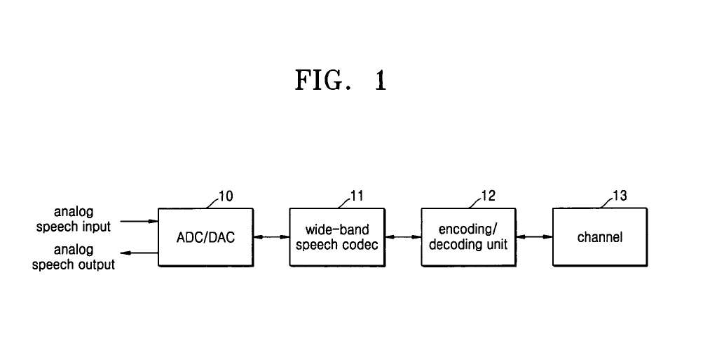

FIG. 1 is a block diagram of an audio unit in a conventional wide-band speech signal codec.

An analog speech input signal is converted into a digital speech input signal by an ADC/DAC 10. The digital speech input signal is input to a wide-band speech codec 11. An encoding/decoding unit 12 encodes and packetizes an input signal and transmits the packetized signal to a channel 13. The encoding/decoding unit 12 decodes packet data (for example, a speech signal) received from the channel 13. The decoded speech signal is converted into an analog speech signal by the ADC/DAC 10. The analog speech signal is output through a speaker.

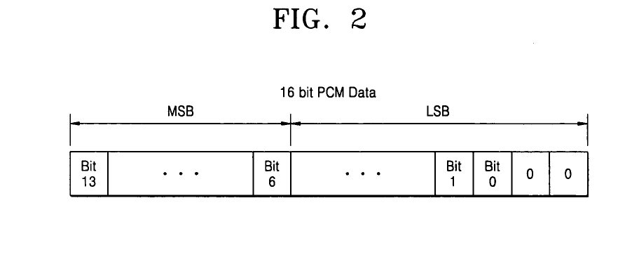

The signal input to the wide-band speech codec 11 via the ADC/DAC 10 is a 16 bit linear PCM (Pulse Code Modulation) signal having a 16 bit format. A detailed bit distribution of the input signal is shown in FIG. 2. Referring to FIG. 2, the last two bits of the input signal have logic level 0 and therefore the two bits should be shifted to the right direction when the codec processes the signal.

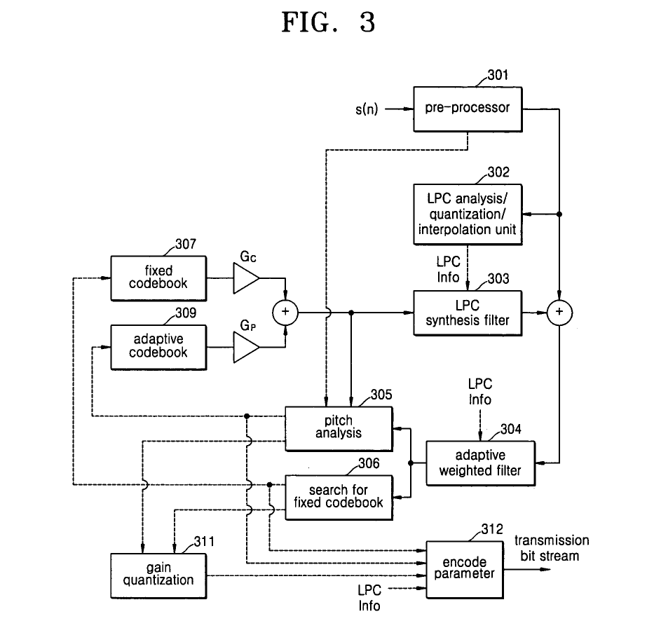

To implement the wide-band speech codec 11, shown in FIG. 1 at a low transmission rate, a CELP type codec is generally used. A general CELP type codec is shown in FIG. 3.

First, an input speech signal s(n) is subjected to pre-processing by a preprocessor 301 and then is subjected to LPC analysis in an LPC analysis/quantization interpolation unit 302.

$$A ( z ) = 1 + {\sum }_{i = 1}^{m} {a}_{i} {z}^{- i} \qquad ( 1 )$$

Here, A(z) is an analysis filter obtained from the LPC analysis/quantization interpolation unit 302, and aᵢ is an LPC coefficient. An LPC coefficient aᵢ which has been analyzed and then constructs an LPC synthesis filter 303. The LPC synthesis filter 303 is given by Equation 2. A prediction order is determined by a value m. A narrow-band speech codec has a prediction order of 10, while a wide-band speech codec has a prediction order of 10 through 20.

$$H ( z ) = \frac{1}{\hat{A ( z )}} = \frac{1}{1 + {\sum }_{i = 1}^{m} \hat{{a}_{i}} {z}^{- i}} \qquad ( 2 )$$

Here, H(z) is the LPC synthesis filter 303, Â(z) is a quantized A(z), and âᵢ is the quantized LPC coefficient. That is, the LPC coefficient is quantized for transmission and the quantized LPC coefficient constructs the LPC synthesis filter 303. An excitation signal is obtained through a closed loop including the LPC synthesis filter 303. A target signal for obtaining the excitation signal can generally be obtained by passing an input signal through an adaptive weighted filter 304. As such, by analyzing the input signal with the adaptive weighted filter 304 and obtaining the excitation signal, a restored speech can have better quality. The excitation signal includes a long-term correlation signal obtained from an adaptive codebook 309 and a short-term correlation signal obtained from a fixed codebook 307. The long term correlation signal and the short term correlation signal are multiplied respectively, by proper gains G_{P} and G_{C}, thereby forming an excitation signal to be output to the LPC synthesis filter 303.

The CELP method uses an AbS (Analysis by Synthesis) method that performs direct synthesis and then performs analysis when searching for the fixed codebook 307 and the adaptive codebook 309. However, since direct synthesis is performed, a large amount of calculation is necessary. The LPC synthesis filter 303 for the long-term correlation signal is given by.

$$\frac{1}{B ( z )} = \frac{1}{1 - {G}_{P} {z}^{- T}} \qquad ( 3 )$$

Here, Gₚ is a proper gain and T is a pitch period obtained by pitch analysis 305. A present signal is predicted in a long-term using a preceding synthesis signal z^{-T}. By multiplying the predicted present signal by the gain Gₚ, a present long-term correlation signal B(z) is obtained. After the pitch period T and the gain Gₚ of the long-term correlation signal are obtained, a fixed codebook search 306 is executed to obtain a more precise excitation signal.

A target signal for the fixed codebook 306 search is a signal which does not include the long-term correlation signal. A fixed codebook 307 is implemented using various methods and the most commonly used fixed codebook is an algebraic codebook. The algebraic codebook can be used without memory for storing a codebook and a required innovation signal can be obtained at a high speed. A disadvantage of the algebraic codebook is that a large amount of calculation is required. However, such a large amount of calculation does not cause difficulties since various fast algorithms have been proposed. Coefficients obtained from the algebraic codebook search are pulse location information and symbol information. After the fixed codebook is obtained, gains corresponding to the fixed codebook should be obtained. Gains of the fixed codebook are obtained along with gains of the adaptive codebook through a closed loop. The obtained gains are vector-quantized using a gain quantization block 311. As such, if analysis for all of the frames is terminated, a parameter encoding unit 312 encodes the frames into a bit stream using the obtained coefficients and then transmits the bit stream.

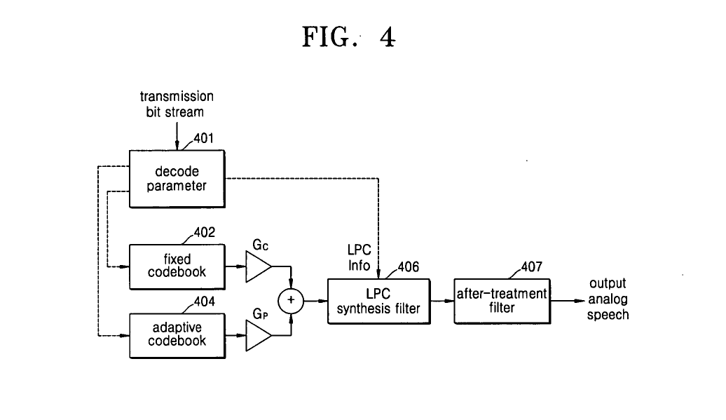

FIG. 4 shows a general CELP type decoder. The CELP type decoder converts the bit stream transmitted from the encoder of FIG. 3 into respective coefficients in a parameter decoding unit 401 so that the respective coefficients may be used in corresponding modules 402, 404, 406,407. First, an LPC synthesis filter 406 is constructed using a decoded LPC coefficient. Indexes of a fixed codebook 402 and an adaptive codebook 404 are decoded and multiplied by the gains G_{c} and Gₚ, respectively, to create an excitation signal. The excitation signal is passed through the LPC synthesis filter 406 to create a synthesis signal. The synthesis signal is passed through an after-treatment filter 407 to create high-quality analog output speech.

Heretofore, a general CELP structure has been described. The preferred embodiment of the present invention uses such a CELP structure, however, it generates a random sequence and models an excitation signal without the pitch analysis 305 and the fixed codebook search 306 in order to achieve a low transmission rate.

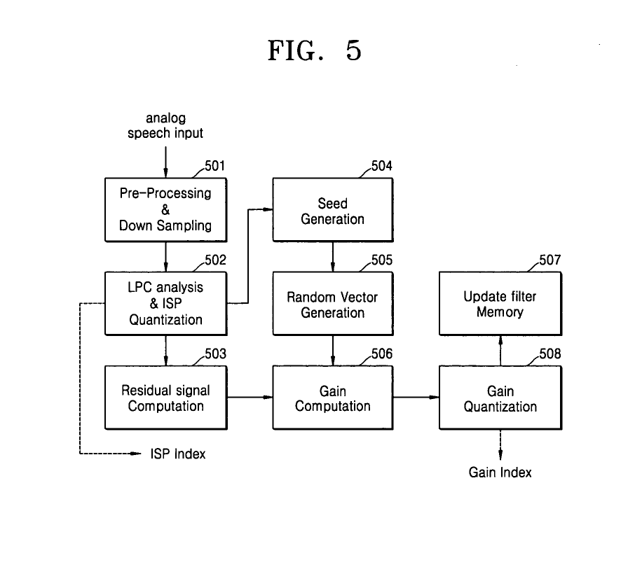

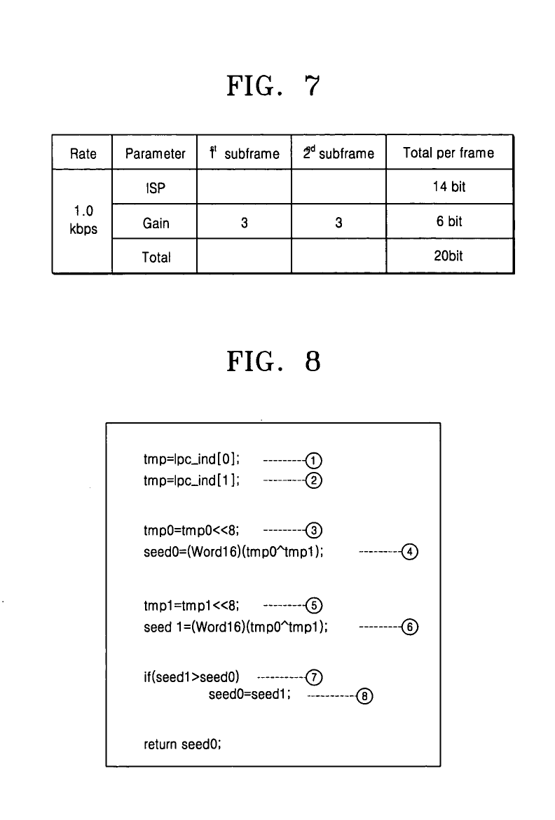

FIG. 5 is a block diagram showing a construction of an encoder according to the preferred embodiment of the present invention. A speech encoder according to the present invention is designed to use a band of 50-6400 Hz and have a transmission rate of 1.0 kbps. Two characteristic parameters, an ISP index and a gain index, are extracted and transmitted to a decoder. Each of the parameters consists of two sub-frames and bit allocation for each of the sub-frames is shown in FIG. 7.

The encoder of FIG. 5 according to the present invention performs an analysis of each frame.

A pre-processing and down-sampling unit 501 down-samples at 12.8 kHz an input speech signal sampled at 16 kHz and then creates a signal below 50 Hz from which DC components are removed.

An LPC-analysis and ISP quantization unit 502 receives the created signal and obtains an LPC coefficient using a Levinson-Durbin method through an autocorrelation function. The order of a linear prediction coefficient is 16. A short-term correlation A(z) of a speech signal is analyzed using the linear prediction coefficient of Equation 1.

Since aᵢ is quantized to obtain âᵢ and a synthesis filter is constructed using âᵢ, it is important to perform quantization while minimizing a quantization error using the LPC coefficient. However, since the LPC coefficient has a large dynamic range, it is difficult to quantize. For this reason, the LPC coefficient is converted into an ISP coefficient having a small dynamic range, which facilitates a stability check and is mathematically equal to the LPC coefficient, before the ISP coefficient is subjected to quantization.

Quantization of the ISP coefficient is performed using an SVQ (Split Vector Quantization) method. 14 bits are allocated for such quantization and construct two splits. The 7-bit splits are quantized using one split codebooks for each.

A synthesis filter using a quantized short-term correlation is expressed by Equation 2. In Equation 2, âᵢ represents a quantized LPC coefficient and m represents a prediction order. The preferred embodiment of the present invention uses m=16.

The remaining process involves modeling an excitation signal of the obtained LP synthesis filter which is performed for each sub-frame.

First, a residual signal computation unit 503 passes an output signal sent from the pre-processing and down-sampling unit 501 through the analysis filter of Equation 3 (above mentioned) to obtain an LP residual signal. The residual signal is converted to a target signal which models an excitation signal of the LP synthesis filter.

To model an excitation signal, a random vector is used. A gaussian random vector is generally used as the random vector. Modeling is performed by using a method that generates a random sequence using the gaussian random vector and multiplies the random sequence by a proper gain. The random vector is obtained from a random vector generation unit 505. The random vector can be obtained by receiving a seed from a seed generation unit 504 and storing a seed for each of the sub-frames in FIG. 7. Since the seed is continuously updated, the seed is sequentially generated after it is once determined. The seed is determined by

Seed=(word 16)(seed*31821 (=0×7c4d)+13849(=0×3619)) (4)

Here, (word 16) represents a 16 bit integer value. The seed is continuously updated by Equation 4. However, if frame erasure occurs, a value of the encoder becomes different from that of the decoder. To prevent such frame erasure, a method of generating a seed value using a transmitted parameter is used.

Seed creation by the seed generation block 504 can be performed through a method shown in FIG. 8, using two indexes transmitted from the LPC analysis and ISP quantization block 502.

FIG. 8 illustrates a seed generation method programmed using the C programming language.

Referring to FIG. 8, in \mathring{1}, Ipc_ind[0] represents a first index of the gain and ISP indexes of a transmitted LPC parameter. In \mathring{2}, Ipc_ind[1] represents a second index of the gain and ISP indexes of the transmitted LPC parameter.

To obtain a seed 0, Ipc_ind[0] is shifted to the left by 8 bits in \mathring{3}, an exclusive OR operation of the shifted value and Ipc_ind[1] is performed in \mathring{4}, and then the result is stored as a 16 bit natural number. To obtain a seed 1, Ipc_ind[1] is shifted to the left by 8 bits in \mathring{5}, an exclusive OR operation of the shifted value and Ipc_ind[0] is performed in \mathring{6}, and then the result is stored as a 16 bit natural number. As such, if seed 0 and seed 1 are determined, a seed is determined as the maximum value of seed 0 and seed 1 in \mathring{7} and \mathring{8}.

The Random vector generation unit 505 obtains random vectors for each of the sub-frames using the obtained seed. The number of the random vectors for each of the sub-frames is 128.

A gain computation unit 506 calculates a gain by which the obtained random vector is multiplied. That is, a random vector scaled by the gain becomes an excitation signal of an LP synthesis signal.

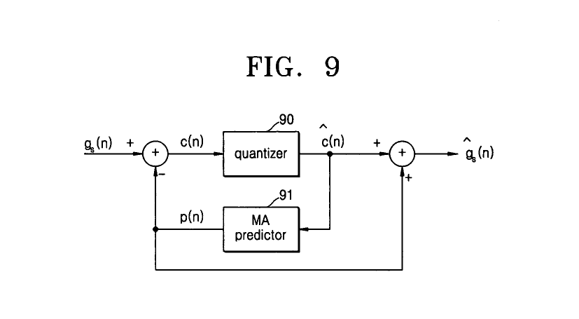

A gain (gₛ) is given by

$${g}_{s} = 0.75 * \sqrt{\frac{{\sum }_{n = 0}^{127} {[ r ( n ) ]}^{2}}{{\sum }_{n = 0}^{127} {[ {e}_{rand} ( n ) ]}^{2}}} \qquad ( 5 )$$

where r(n) is the LP residual signal, 0.75 is a gain attenuation factor and e_{rand}(n) is the random vector. FIG. 9 is a gain quantization unit of the encoder. Referring to FIGS. 5 and 9, in a gain quantization unit 508, a gain gₛ(n) of a present frame is quantized by quantizing a prediction error vector obtained from the subtraction of a value, that is, estimated by a secondary MA (Moving Average) predictor 91 from the gain. A prediction error vector c(n) as an input signal of the quantizer 90 is expressed by.

c(n)=gₛ(n)−p(n) (6)

Here, gₛ(n) is a gain obtained from the gain calculation block 506, and a prediction vector p(n) is obtained by the secondary MA predictor 91 using a prediction error vector Ĉ(n) quantized in a preceding sub-frame according to Equation 7.

$$p ( n ) = {\sum }_{j = 1}^{2} {g}_{j} \hat{c} ( n - j ) . \qquad ( 7 )$$

Here, Ĉ(n) is a prediction error vector quantized in an n-th frame and gⱼ is a coefficient of the MA predictor 91. In the preferred embodiment of the present invention, a value [g₁, g₂] is set to [0.28, 0.11]. A quantized gain [ĝₛ(n)] can be obtained by adding the quantized prediction error vector Ĉ(n) to the prediction vector p(n) according to

ĝₛ(n)=ĉ(n)+p(n) (8)

The quantizer 90 of FIG. 9 scalar-quantizes the prediction vector c(n) of the present frame. Since 3 bits are allocated for scalar-quantization, 8 codewords are used for scalar-quantization. When quantization is terminated, an update filter memory unit 507 performs a memory update for the following frame.

A memory update is performed by updating a speech signal buffer, a weighted speech signal buffer, and an excitation signal buffer. After encoding for each frame is terminated, an index that is transmitted to the decoder is 20 bits including an LPC index of 14 bits and a gain index of 6 bits.

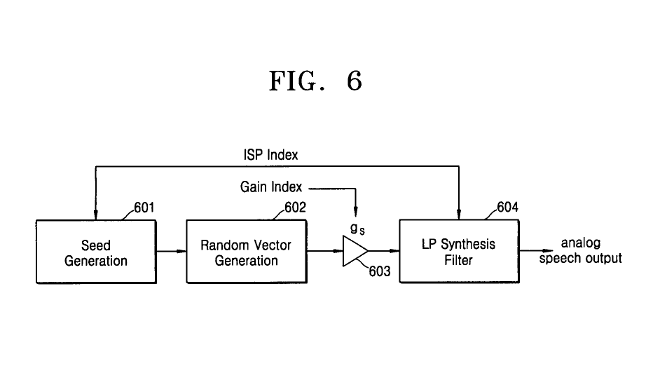

FIG. 6 is a block diagram showing a configuration of the decoder. The decoder constructs a LP synthesis filter 604 using the transmitted indexes (LPC index and gain index) and obtains a gain gₛ of a unit 603. Then, a seed is obtained from the seed generation block 601 using the transmitted LPC index, by the method proposed in FIG. 8, and the random vector generation unit 602 creates a random vector using the seed. A signal obtained by multiplying the random vector by a gain gₛ becomes an excitation signal. The excitation signal is passed through the LP synthesis filter 604 and thus a synthesized speech signal is restored.

As described above, according to the preferred embodiment of the present invention, it is possible to flexibly control a transmission rate according to the characteristics of speech signals, and particularly, to efficiently encode/decode a wide-band low transmission rate speech signal during the transmission interval of a ‘silence’ signal. Also, by generating and adding only a band of 6.4-7 kHz using a higher band modeling technique, complete wide-band speech encoding can be achieved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An encoder for a wide-band low transmission rate speech signal, the encode comprising:
a pre-processing and down-sampling unit, which down-samples a speech signal frame sampled at a high frequency, at a low frequency, and outputs a speech signal frame without DC components;
a LPC analysis and ISP quantization unit, which receives the down-sampled speech signal, determines a linear prediction coefficient of the received speech signal frame, converts the linear prediction coefficient into an ISP coefficient, quantizes the converted result, and outputs an index of the ISP coefficient;
a residual signal calculation unit, which calculates a residual signal that models an excitation signal of a synthesis filter for the down-sampled speech signal;
a random vector generation block which generates a random vector for modeling the excitation signal;
a gain calculation block, which calculates a gain for scaling the random vector; and
a gain quantization block, which quantizes the gain and creates an index of the gain.

2. The encoder of claim 1, wherein modeling is performed for each of two sub-frames of the speech signal frame and is performed by generating a random sequence using the random vector and multiplying the random sequence by the gain.

3. The encoder of claim 2, wherein the random vector is generated by storing a seed generated by a predetermined method for each of the sub-frames.

4. The encoder of claim 3, wherein the seed is obtained, by generating a value obtained by shifting a first index among the two indexes transmitted by the LPC analysis and ISP quantization block to the left by 8 bits, performing an exclusive OR operation on the shifted value and the second index among the indexes, setting the result as a first seed value (seed 0), shifting the second index to the left by 8 bits, performing an exclusive OR operation of the second shifted value and the first index, setting the result as a second seed value (seed 1), and determining the maximum value of the seed 0 and the seed 1 as a final seed value.

5. The encoder of claim 1, wherein the gain is calculated based on the residual signal and the random vector.

6. The encoder of claim 1, wherein the ISP index and the gain index are quantized to 14 bits and 6 bits, respectively.

7. The encoder of claim 1, wherein the gain is quantized by quantizing a present prediction error vector obtained by subtracting a predicted value of a pre-quantized prediction error vector value for a preceding frame from the gain.
